(19) United States
(12) Patent Application Publication
(10) Pub. No.: US 2010/0012337 A1
(43) Pub. Date: Jan. 21, 2010

(54) PERCUSSIVE MECHANISM OF AN ELECTRIC HAND-HELD MACHINE TOOL

(76) Inventor: Gerhard Meixner, Filderstadt (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/519,100

(22) PCT Filed: Oct. 17, 2007
(86) PCT No.: PCT/EP07/61082

§ 371 Date: Jun. 12, 2009

(51) Int. Cl. B25D 11/00

(52) U.S. Cl. 173/114

(57) ABSTRACT

The invention relates to a percussive mechanism of an electric hand-held machine tool, in particular a percussive hammer, which includes an electric motor, a transmission, and an eccentric arrangement for producing the percussion. The transmission has a first transmission stage, which is coupled with the electric motor. The first transmission stage is adjoined by a second transmission stage, which is coupled with the eccentric arrangement. The invention provides that the second transmission stage has a transmission gearwheel which is formed as an eccentric gearwheel.

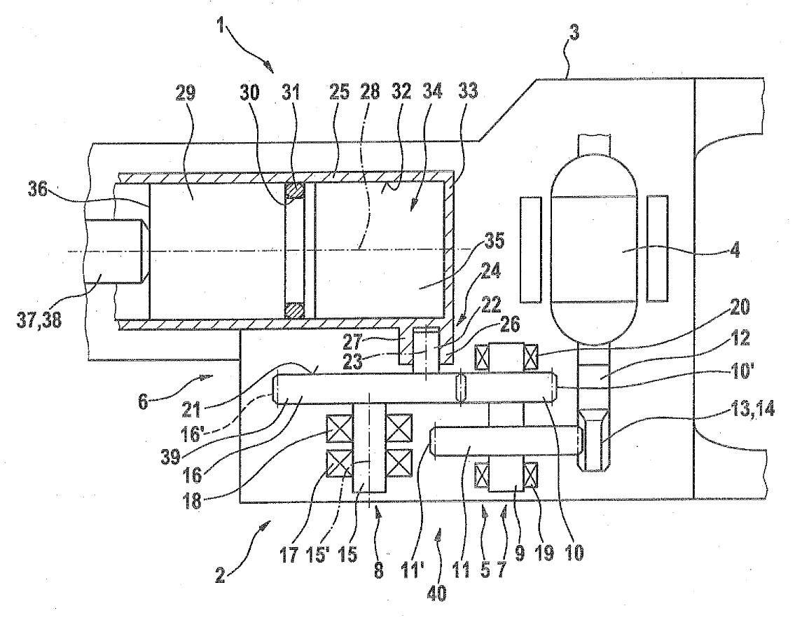

The invention relates to an impact mechanism of an electric hand-held power tool, in particular a percussion hammer, having an electric motor, a transmission, and a cam mechanism for impact generation.

### PRIOR ART

Impact mechanisms for electric hand-held power tools are known. For example, there are electrically driven percussion hammers or rotary hammers, which have a cam mechanism that is driven by an electric motor via a transmission; the cam mechanism converts the rotary motion of the electric motor and transmission into a translatory, i.e. linear, motion in the hammering direction.

### DISCLOSURE OF THE INVENTION

According to the invention, the transmission has a first transmission stage that is coupled to the electric motor and this first transmission stage is connected to a second transmission stage that is coupled to the cam mechanism; the second transmission stage has a transmission gear that is embodied in the form of a cam gear. A two-stage transmission is thus provided with a cam gear of the cam mechanism and makes it possible to provide a high step-up ratio or step-down ratio while requiring a small amount of space—in comparison to a single-stage transmission. Since the transmission gear of the second transmission stage is embodied as a cam gear, there is no need for an additional cam gear. The cam gear according to the invention consequently fulfills two functions, on the one hand, it serves to transmit force from the preceding transmission stage and on the other hand, by means of the cam gear, it converts the rotary motion into the desired translatory/linear motion.

This therefore eliminates a transmission gear of the second transmission stage, which would only be required for driving the second transmission stage by means of the first transmission stage. The second transmission stage and therefore also the entire transmission is consequently slimmer and more compact. This leads to reductions in manufacturing costs, weight, and space.

The first transmission stage suitably has a first rotatably supported shaft on which a transmission gear is mounted in a rotationally fixed fashion. The electric motor is suitably equipped with a drive shaft that is provided with a gearing. The gearing is advantageously embodied in the drive shaft in such a way that the diameter of the drive shaft does not change over its longitudinal span. The gearing of the drive shaft suitably cooperates with the transmission gear of the first transmission stage, as a result of which, the transmission gear of the first transmission stage constitutes a transmission gear that is driven by the electric motor. The diameter of the gearing and the diameter of the transmission gear of the first transmission stage are suitably embodied of different sizes so as to embody a step-up or step-down ratio, respectively.

According to the invention, the second transmission stage has a second rotatably supported shaft on which the cam gear is mounted in a rotationally fixed fashion. The cam gear of the second transmission stage suitably cooperates with the transmission gear of the first transmission stage so that the cam gear is driven by the transmission gear of the second transmission stage.

In an alternative embodiment of the invention, the first transmission stage has two transmission gears: the one cooperates with the gearing of the drive shaft of the electric motor and the other cooperates with the cam gear (of the second transmission stage). This makes it possible to achieve an even greater step-up or step-down range for the transmission since the transmission gears of the second transmission stage are advantageously embodied of different sizes, i.e. have different diameters.

The cam gear is suitably provided with a cam on its free end surface. The cam is composed of an element that protrudes from the end surface and is eccentrically supported on the cam gear. The expression “the free end surface” is understood here to be an end surface of the cam gear that is closed and terminates axially with one end of the shaft. Preferably, the shaft of the second transmission stage is supported at one end to achieve this. The cam is advantageously embodied essentially in the form of a circular cylinder; its axis is oriented parallel to and spaced apart from the rotation axis of the shaft and the cam gear.

According to a modification of the invention, the impact mechanism has a hammer tube. This hammer tube is operatively connected to a hammering tool so that a hammering force can be transmitted from the hammer tube to the hammering tool. According to the invention, the cam of the cam gear engages in a sliding block guide of the hammer tube, thus converting a rotary motion into a translatory motion.

The sliding block guide is advantageously comprised of two opposing ribs; the ribs are preferably embodied of one piece with the hammer tube. The sliding block guide, or more precisely the ribs, is/are situated on the outside of the hammer tube. The cam mechanism composed of the cam, the cam gear, and the sliding block guide consequently produces a translatory, oscillating motion of the hammer tube.

In another embodiment, the sliding block guide is comprised of a groove-like recess in the hammer tube in which the cam engages. It is also conceivable for the sliding block guide to be comprised of a combination of the ribs and the recess.

The sliding block guide is advantageously situated essentially perpendicular to the hammering direction. In an alternative embodiment, the cam is operatively connected via a connecting rod to a piston that is able to move in a stationary hammer tube so that the piston executes a translatory, oscillating motion and produces impacts by means of compressed air, with the piston suitably resting in scaled fashion against the hammer tube interior of the stationary hammer tube.

According to a modification of the invention, the transmission gears and/or the cam gear are/is of one piece with the respective shaft(s).

The invention also relates to an electric hand-guided power tool, in particular a percussion hammer, having an impact mechanism of the type described above.

### BRIEF DESCRIPTION OF THE DRAWING

The invention will be explained in detail below in conjunction with one FIGURE.

The sole FIGURE shows an exemplary embodiment of the invention.

### EMBODIMENT(S) OF THE INVENTION

The sole FIGURE shows a schematic side view of a part of an electric hand-guided power tool 1 in an exemplary embodiment of the invention, which is embodied in the form of a percussion hammer and has an impact mechanism 2 that is contained in a housing 3 of the percussion hammer. The impact mechanism is essentially composed of an electric motor 4, a transmission 5 driven by the electric motor 4, and a cam mechanism 6. The transmission 5 has a first transmission stage 7 and a second transmission stage 8. The first transmission stage 7 is composed of a rotatably supported shaft 9 on which two transmission gears 10 and 11, each with a respective gearing 10′ and 11′, are spaced apart from each other and mounted onto the shaft 9 in a rotationally fixed fashion. The transmission gear 10 has a smaller diameter than the transmission gear 11. The electric motor 4 has a drive shaft 12 that is situated parallel to the shaft 9 of the first transmission stage. A gearing 14 is embodied at the free end 13 of the drive shaft 12; the gearing 14 cooperates with the gearing 11′ of the transmission gear 11 of the first transmission stage 7. The diameter of the drive shaft 12 and of the gearing 14 here is significantly smaller than the diameter of the gearing 11′ and of the transmission gear 11, thus embodying a step-down ratio that reduces the speed and increases the torque from the drive shaft 12 to the shaft 9.

The second transmission stage 8 is essentially composed of a rotatably supported shaft 15 on the one end of which is situated a transmission gear 39 embodied in the form of a cam gear 16, which is mounted onto the shaft 15 in a rotationally fixed fashion. The outer circumference of the cam gear 16 is provided with a gearing 16′ that cooperates with the gearing 10′ of the transmission gear 10; the shaft 9 and 15 are also oriented parallel to each other. The shaft 15 is supported by two roller bearings 17 and 18 spaced apart from each other. The transmission stage 8 is thus supported at one end, whereas the shaft 9 of the first transmission stage 7 is supported by a respective roller bearing 19, 20 at each of its two ends and the transmission gears 10 and 11 are situated between the roller bearings 19 and 20.

On the free end surface 21 of the cam gear 16, a cam 22 is provided, which is embodied essentially in the form of a circular cylinder whose (symmetry) axis 23 is eccentrically oriented parallel to the rotation axis 15′ of the shaft 15 and of the cam gear 16. The cam 22 engages in a sliding block guide 24 that is situated on a hammer tube 25 of the impact mechanism 2. The sliding block guide is comprised of two opposing ribs 26 and 27 between which the cam 22 lies. In the exemplary embodiment shown, the ribs 26 and 27 are embodied of one piece with the hammer tube 25. The ribs 26 and 27 here extend essentially perpendicular to the plane of the drawing and to the hammering direction. The hammer tube 25 here is supported so that the cam mechanism 6 moves it in a translatory and oscillating, i.e. reciprocating, fashion along a working axis 28 that defines the hammering direction. A striking element 29 is contained in the hammer tube 25; its cross section essentially corresponds to the cross section of the hammer tube 25 and it is able to move along the working axis 28 in the hammer tube 25. The striking element 29 has a groove 30 on its outer circumference in which an O-ring 31 lies, which is pressed against the inside 32 of the hammer tube 25. The striking element 29 is situated spaced apart from the closed end 33 of the hammer tube 25 so that there is a free space 34 between the end 33 of the hammer tube 25 and the striking element 29. The elastic O-ring seals this free space 34, thus producing an air cushion 35.

If the cam gear 16 is driven, the cam mechanism 6 causes the hammer tube 25 to be moved in translatory fashion along the axis 28 as described above, thus also moving the striking element 29 along with it. If the hammering side 36 of the striking element 29 comes into contact with a hammering tool 37, only part of whose hammer tool shaft 38 is shown here, en the striking element 29 is slid in the direction toward the closed end 33 of the hammer tube 25, causing the pressure of the air cushion 35 in the free space 34 to increase due to the reduced volume, thus cushioning the impact and not transmitting it directly to the transmission 5.

Because the cam gear 16 is constituted by the transmission gear 39, this yields a particularly compact design of the transmission 5 for the percussion hammer 1. The cam gear 16 consequently has a double function: on the one hand, it serves the cam mechanism 6 and on the other hand, it functions as a transmission gear 39 for the transmission 5. The diameter of the cam gear 16 and of the gearing 16′ here is significantly larger than the diameter of the transmission gear 10 and of the gearing 10′ so that here, too, a step-down ratio is produced. The transmission 5 is consequently a step-down gear system 40 that makes it possible to use a smaller, lighter electric motor 4 that does provide a high speed, but only provides a low torque. The step-down gear system 40 reduces the speed and increases the torque so that a desirable, necessary hammering force is produced. In lieu of the spur gearings (14, 11′ and 10′, 16′) shown here, bevel gearings could also be provided. The sliding block guide 24 can alternatively be situated on the working axis; to this end, the end 33 of the hammer tube 25 is advantageously provided with a projection on which the sliding block guide 24 is situated. In this case, the length of the projection—viewed in the working axis direction—suitably corresponds to at least the diameter of the cam gear.

As an alternative to the sliding block guide 24, it is conceivable to provide a connecting rod for impact generation, which rod is rotatably supported on the cam 22 and acts on a piston that is movably supported in a fixed, i.e. stationary, hammer tube. The function of a (hammering) piston of this kind is known to those skilled in the art and need not be explained in greater detail here.

1-19. (canceled)

20. An impact mechanism of an electric hand-guided power tool, in particular a percussion hammer, comprising:
an electric motor;
a transmission having a first transmission stage that is coupled to the electric motor and that is connected to a second transmission stage; and
a cam mechanism for impact generation, the cam mechanism being coupled to the second transmission stage, wherein the second transmission stage has a transmission gear that is embodied in the form of a cam gear.

21. The impact mechanism as recited in claim 20, wherein the first transmission stage has a first rotatably supported shaft to which is mounted at least one transmission gear.

22. The impact mechanism as recited in claim 20, wherein the electric motor has a drive shaft in which a gearing is embodied.

23. The impact mechanism as recited in claim 22, wherein the gearing of the drive shaft cooperates with the transmission gear of the first transmission stage.

24. The impact mechanism as recited in claim 20, wherein the second transmission stage has a rotatably supported shaft to which the cam gear is mounted in a rotationally fixed fashion.

25. The impact mechanism as recited in claim 21, wherein the second transmission stage has a second rotatably supported shaft to which the cam gear is mounted in a rotationally fixed fashion.

26. The impact mechanism as recited in claim 20, wherein the cam gear of the second transmission stage cooperates with a transmission gear of the first transmission stage.

27. The impact mechanism as recited in claim 22, wherein the first transmission stage has two transmission gears, the one cooperating with the gearing of the drive shaft of the electric motor and the other cooperating with the cam gear of the second transmission stage.

28. The impact mechanism as recited in claim 20, wherein the cam gear has a cam on its free end surface.

29. The impact mechanism as recited in claim 25, wherein the second shaft of the second transmission stage is supported at one end in the electric hand-guided power tool.

30. The impact mechanism as recited in claim 28, wherein the cam is embodied essentially in the form of a circular cylinder.

31. The impact mechanism as recited in claim 20, further comprising a hammer tube.

32. The impact mechanism as recited in claim 31, wherein the cam mechanism engages in a sliding block guide of the hammer tube.

33. The impact mechanism as recited in claim 32, wherein the sliding block guide is comprised of two opposing ribs.

34. The impact mechanism as recited in claim 33, wherein the ribs are embodied in one piece with the hammer tube.

35. The impact mechanism as recited in claim 32, wherein the sliding block guide is comprised of a groove-like recess in the hammer tube.

36. The impact mechanism as recited in claim 32, wherein the sliding block guide is oriented essentially perpendicular to a hammering direction.

37. The impact mechanism as recited in claim 32, wherein the cam mechanism is operatively connected via a connecting rod to a piston that is able to move in the hammer tube.

38. The impact mechanism as recited in claim 20, wherein the transmission is a step-down gear system.

39. An electric hand-guided power tool, in particular a percussion hammer, having an impact mechanism as recited in claim 20.
